(19) United States
(12) Patent Application Publication
(10) Pub. No.: US 2016/0232533 A1
(43) Pub. Date: Aug. 11, 2016

(54) Automation of Personal Finance, Credit Offerings and Credit Risk Data Reporting

(71) Applicant: Lawrence F. Glaser, Fairfax Stn., VA (US)

(72) Inventor: Lawrence F. Glaser, Fairfax Stn., VA (US)

(21) Appl. No.: 14/979,447

(22) Filed: Dec. 27, 2015

Related U.S. Application Data
(60) Provisional application No. 62/097,881, filed on Dec. 30, 2014.

(51) Int. Cl. G06Q 20/40; G06Q 20/10; G06Q 20/24

(52) U.S. Cl. CPC G06Q 20/4016; G06Q 20/24; G06Q 20/10; G06Q 20/40145

(57) ABSTRACT

Per the terms of service a user executes, the user agrees to perform all commerce, communications and data access possible through their portable and stationary electronic device(s) and allow the associated service to monitor all of their activities. In return, the service tracks their location, monitors and executes all financial transactions, builds upon the assurance of the identity of the user, discourages or eliminates identity theft and is in the best position to provide total financial counseling to the user. Store owners or credit companies can reach the user to acquire more complete information about the User can then offer credit with full automation of all functions, while all parties will benefit from reduced risk.

### BACKGROUND

1. Field of the Invention

The field of this invention is a rapidly evolving field which includes how, when and where a unique user transacts their communications, commerce and data access. As such, the field of computing, software, networking, credit, ecommerce, social networking, authentication and data mining are all inclusive to this invention.

2. Description of the Prior Art

Because of the increasing sophistication of portable and stationary electronic devices which a user may utilize to communicate, access data and perform a transaction, it is possible to offer full time, real time, authenticated monitoring of a user's identity, the identity of their electronic devices, their precise location and all of their activities. It is also possible to provide a continual compilation of the data associated with these devices and any events associated with these devices, scoring the reliability through which the monitoring systems are able to determine with the use of multiple biometric gathering tools and other tools discussed in this specification and other related specifications. The depth at which any device can offer access to a unique authenticated user and their activities varies per device, per network, and in a cloud-based solution, as the network or the cloud are not the device and are dependent upon the device’ sophistication and features. The terms of service of any agreement between carriers and their clients usually asks for full access to the user's activities, however, nothing is typically offered to the User in return. Examples of prior art include PCs which are networked, utilizing the Internet to communicate. Cell phones, tablets and other similar devices which rely on cellular communications access also represent the prior art relative to this invention. The prior art typically relies upon a combination of technologies to present to the carrier the data the carrier can store, mine and respond to, as well as selectively passing on data to allow the user to access independent facilities, transact commerce and both make and receive communications. Current credit reports from all credit reporting sources may well be outdated by years, incorrect and may include hits which violate an individual's federal and state rights.

The User and any vendor or financial lending source should be able to benefit from up to date information, genuine real time risk analysis and both the User and any other party intending to transact with the User, should be able to benefit from current credit and financial information, risk analysis even to the extent or warning the User about the risk associated with a given item purchase, transaction, credit source or any other factor which could pose a risk to the User. The invention seeks to provide the very core elements of government dynamics, a concept which won the Nobel prize. If all parties in a transaction receive the best deal for their purposes, then all parties succeed and receive the greatest benefit possible. It is impossible to achieve this governing dynamic without the prerequisite tools, which this invention brings to bear. 20140058924 provides credit but without Automatic/automatically, biometric, multibiometric, confirmed location/location, confirmed device, confirmed user to then automatically offer credit, automatically manage credit for the user, automatically curb credit per the user's credit counseling settings or to automatically establish certification details.

The present invention overcomes these and other limitations of the prior art.

### SUMMARY

The present invention provides improvements in monitoring the authenticated user, tracking the movement with authentication of the movement data, biometrics or multi-biometrics with further authentication means deployed to assure the validity of the biometrics associate with the authenticated user. These advances yield the chance to offer an agreement, “Terms of Service” (TOS) which then provides the best methods and offerings for improving the user's experience, maximizing their value while reducing and eliminating risk. In the terms of service of this invention, the user is allowed to decide levels of access to their data in order to receive something back in return, for allowing the access which the user deems to be of actual value to them, and not just a time wasting pop up or annoyance. This applies equally to all participants in such an invention reaching out to lenders, governments, institutions, venues, law enforcement, store owners and social network sites, to name a few potential users and beneficiaries of the invention.

Users are now able to use a cell phone, for example, to conduct commerce and to pass on credit card related data to pay for a transaction. This is but one example and it demonstrates the rapid layering of technology relevant to this invention. When industry works independently to provide more and more access to features, functions and services, such as we have witnessed in the PC and Cell accessing and transacting commerce through a network, the public enemy seizes upon the opportunities to commit identity theft, credit card fraud and other such negative-inference activities which are reflected in negative impact upon what may be an innocent user. The focus of improvement here is to inform the user of new options they may have by way of their service agreement, the terms of service, matched to new hardware, new software and improved networks the user has elected to utilize, according to this invention, that can offer these new options and fully support them. The inventor believes these new options, and the proposed changes to hardware, software and networks associated with this invention, will greatly benefit all parties who are involved in these forms of communications, transactions and data access. Even data structure and data base formats may change as a direct result of this invention, for example, to associate multiple biometrics with a given single action which in turn, formed a transaction of importance to the user and to other parties involved in the transaction.

Other attempts to capitalize on users' data seek to do so without user consent, or, in a manner the user was not completely aware of. The present invention makes user awareness formal. It does so without jeopardizing user security as encryption and biometric access is anticipated as the exclusive means to access data in the devices, limited values are stored there and furthermore, viewing detailed data may be made off limits according to software settings. For example, how use is made of these data internally to connect the user to the offerings or facilities may remain a trade secret under this invention and only the linking algorithms and scoring algorithms in terms of output, may constitute the visible nature of the services the invention can provide. Doing it this way enhances security.

The present invention overcomes the deficiencies of the known art and the problems that remain unsolved by providing a new form of user identity authentication, user device authentication, user location authentication and user credit rating data. Unlike prior art systems which rely on fallible human operators to calculate many credit-related issues, the present system provides increased automation up to and including fully automated functionality across the full spectrum of the invention's intended usage. For purpose of explaining this invention, as more completely defined below.

User identity authentication 603; refers to a combination of means through which a user's identity can be verified which greatly exceeds and also mathematically exceeds the certainty of existing devices with finger print scanners or retinal scanners. User device authentication; refers to a combination of means through which a user's device's identity can be verified.

User location authentication 604 refers to a combination of means through which a user's location can be verified and transmitted for each communication, data access or transaction, generally tied into the other methods so as to support one another. Eg if I can say User X took step Y with multiple biometrics gathered during the event, I can also determine User X was in position Z when the event took place. Z may include 3 dimensional coordinates and may also automatically relate to other records such as other devices in proximity, what they were doing at that moment and a CCTV (DVR) recording.

User credit rating data 609 refers to combined analysis of real time, recent medium term and longer term data. Item identification refers to Item identification with location data’ Items on store shelves or in warehouses.

A “personalized secure platform” includes, as a non-limiting example, the credit-card form factor devices shown and described in 20140074696 and 20140183269. It may also be a cellphone or smartphone, tablet or other devices described herein and suitably enhanced, if necessary, to perform the functions recited herein. This invention potentially affects everyone, from AMEX (American Express) to TransUnion, Experian, Equifax, Amazon, Yahoo, Safeway, Home Depot, Bank of America, law enforcement and the US Federal Government. This credit weighting and scoring system 617 is far more accurate and fair as compared to current systems because the user is more directly aware of what their credit situation is, en masse, rather than being told by one of the three current credit bureaus. Further, we can automate processes to alert the user if there is any lien, judgment either applied or impending upon all of their property in multiple locations, to assure their credit is as freely available and their scoring is as protected as possible.

It is an object of the invention to provide systems that can track movement in real time through multiple tracking means, not just GPS, to include routers, wi fi, docking, blue tooth, proprietary connections, NIC connections, and through logging and transaction processes, such as a user logging into their email from a work station. As applied in this document, a ‘spatial and temporal relationship’ 618 combines the above-mentioned user location and analysis of the above-mentioned real time movement tracking.

It is an object of the invention to acquire, store and compile multibiometric data for a plurality of actions a unique user takes, up to and including every least common denominator action a user takes (eg grasp a device, touch, wave, gesture, activate, deactivate, select, deselect, erase, forward and so on). Non-limiting examples include turning on a device, or off, volume adjustments, accessing any application, even typing text where each and every keystroke, touch or gesture provides a unique biometric or multibiometric co-associated with the event. This builds a stream of data stored locally on the device and may also be passed on and stored on a server through a network or in a cloud, where the service provider can provide statistically significant assurance of the user's identity, the identity of their device, their location and their activities. We do not limit monitoring of the user's activities to this one device, rather, all devices the user operates and all services they access through any such device. The services may be network resident, cloud based or operate in a distributed manner, such as to have a server present in each venue, or not, as costs allow and features/functions demand. Latency is also a problem which may dictate servers be present in a venue, such as a busy WalMart store, to give a good example. Users in that store receive service from a local server, cutting latency down to a minimal amount.

It is an object of the invention to share any and all of these data species including logging, biometric data, multibiometric data, location data and any other data any one device generates or monitors, with other like devices the unique user owns and operates with emphasis added for mobile devices the user carries.

It is an object of the invention to compile data generated by the user's devices to develop larger data bases of use data to build on the assurance of the user's identity, location, biometrics, multibiometrics and in so doing, then compare between devices the user operates to further compile the data while maintaining the proper tagging 621 so any one lowest common denominator of data can still be reverse traced back to its source based on the time it was generated, the device it was first generated upon and the location of the device. These data can be limited, such as to the last 10 transactions, or set according to other parameters such as last month, last quarter, last day (24 hours) or other settings including sending all data to the beginning of time where the user first started using the device.

It is an object of this invention to allow compression 622 of data stored on the device(s) or in servers (or both) so that a key 605 can be generated to point to the data stack 611, rather than to send all the historic data 610 with each and every transaction. As such, only the key need be transmitted 606 and for protection, the key could be sent encrypted. Along with the key, however, we can still send 623 all the data associated with that one transaction including biometric, multibiometric, device identity and location identity.

It is an object of the invention to allow a transaction inclusive of a key and transaction associated data, to allow the transacting parties to have automatic access to this data to determine authenticity and data congruence for the one transaction. As such, the user's entire history of use of all services through all devices could be used as a crosscheck element in determining identity and authenticity of the action, while not allowing anyone access to the actual raw data. In a manner of speaking, the user's entire history of use with all details possible, is used as an identification key inclusive of the last transaction or command the user executes. It is an object of the invention to transmit user data and compiled use data for all of the devices a unique user operates, for any one given transaction, to assure the device is still in the unique user's possession, the use is authorized, the location is tracked and known and the credit risk is minimized, avoiding identity theft and fraud.

It is an object of the invention to transmit use data and compiled use data for all of the devices a unique user operates, and stream 624 portions of the data through devices the user does not own or, to receive data from devices the user does not own, but are in proximity for any one given transaction, to assure the device is still in the unique user's possession, the use is authorized, the location is tracked and known and the credit risk is minimized, avoiding identity theft and fraud. This means the data from all these devices, associated with the user and not associated with the user, can be sent for a given user transaction. The receipt of this data allows for decompiling to check for authenticity of location, device ID and user ID due to the larger data block sent and received, which includes identical data species for different users and different devices. If, for example, 32 devices send their last 20 transactions complete with all associated data to the service, including a unique User's requested transaction.

It is an object of the invention to pass streamed data and share it with local CCTV (Overhead Camera Security) systems and DVRs (Digital Video Recorders) so as to further verify and associate image data with the user's unique location and make that unique data file available to law enforcement and government for the protection of our nation and for all users of this invention to benefit from even more certainty as to the user's identity and the location of their devices and transactions (See U.S. Application No. 61/913,508, which is incorporated herein by reference).

It is an object of the invention compile lists of objects the user has scanned or created and to send data representing these lists which can provide location data and unique identifiers, further certifying the user's location data. It is an object of the invention to send data representing lists other users in close proximity 612 have also scanned or created to further assure the user's location. It is an object of the invention to allow the service provider who provides services by way of access to all these species of data to allow manufacturers or store owners (Venue owners) to extend credit and credit terms based on what the user has scanned into their list or based on what is in the user's list, however the user ended up with the list of items to which they are interested in purchasing.

It is an object of this invention to allow NFC and WiFi to emit unique identifiers to the user's devices for incorporation in the outbound transmission of data to prove presence and location.

It is an object of the invention to compile data and utilize the data compilation as a marketable aspect, to draw in interested parties who would pay to have the system of this invention provide credit risk scoring so the interested party could provide credit, administer credit and conduct transactions 625 while always having these data associated with each transaction.

It is an object of this invention to allow credit offerings to be made once all these species of data are analyzed, providing a unique opportunity for the credit offering to also pass through a filter representing the user's credit counseling application so as to assure the user does not over extend their credit. The credit offer/sponsor can be made aware of these settings, the user's decision to take or leave the credit offering allowing the credit offer/sponsor to learn more about the user and better the deal if necessary or when necessary to accomplish a goal. This provides sensitivity to each and every user, user device, location and item list or individual item they may show interest in purchasing. The goal here is to provide scoring data and financial data to the service providers, lenders, venues, store owners so as to encourage the best deals and the best interest rates be given to the best customers, even if the rate varies per item or per transaction. At the same time, the system can also score each item to be purchased or a group of prospective items, a transaction, and look individually at credit sources and use, and score them or “risk weigh” them for the User. Every element of the User's interest in completing a transaction which may be scored, is scored and the User can then know how the decision compares to other Users, city-wide, regional or national trend and thus, to determine fairness of the transaction and limit risk for the User. This may represent the first time both ends of a transaction are able to review scoring and data, analytic information, to assure prior to the transaction, all elements of the transaction are fair to all parties and all parties can thereafter, feel the transaction has been a success.

The methods of the present invention are particularly suited, though not limited to, the use of the inventor's Credit Card Form Factor Secure Mobile Computer as disclosed in US #20140074696 and US #20140183269 which are incorporated herein by reference in their entireties. The present invention provides advantages over existing methods used by credit card companies and the major credit bureaus, offering these services directly to all potential beneficiaries including government, law enforcement, store owners and companies, institutions and other users subject to being a party to a given transaction. In an embodiment, a method of the present invention includes scoring the other parties involved with a user in a transaction. Risk scoring relating to the actual parties is provided. A user lacking associated historical data, for example, would assume, a priori, a higher risk score.

### BRIEF DESCRIPTION OF DRAWINGS

FIG. 1 shows elements of a smart-card derived from that shown in FIG. 1 of 20140074696, as an example user device preferable for the present invention

FIG. 2 shows elements of a user device preferable for the present invention, such as the smart-card of FIG. 1, having authentication unit 230 and other elements.

FIG. 3 shows an embodiment of a user device preferable for the present invention, having user location authorization unit 239 integrated into 237 and other elements.

FIG. 4 shows the flow pertaining to a transaction.

FIG. 5 shows functional units used in embodiments of the method of the present invention.

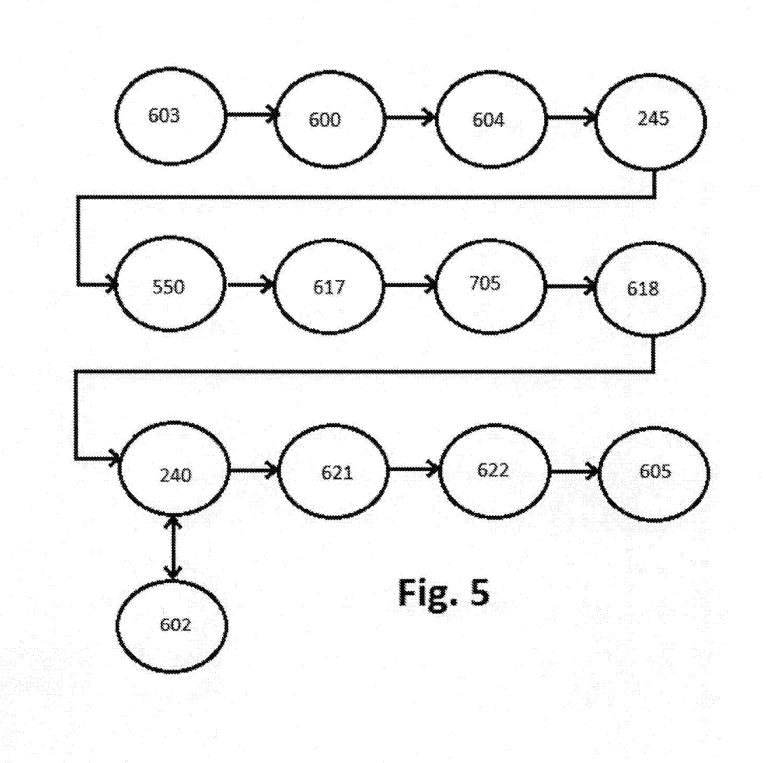

FIG. 6 Credit offering transaction approving system, showing—central system 700 which may be a server, virtual servers, cloud or combinations of the same, able to perform all services contemplated by this invention.

### DETAILED DESCRIPTION

The present invention contemplates the use of a multi-biometric reading (as, in a preferred embodiment, retinal scan taken exactly at the same moment as a retinal capillary scan noting the two distinct images and their overlay, or, finger print and subcutaneous capillary scan again noting their overlay eg how they relate to one another) and, in an embodiment, further verified by receipt of a device unique identifier with or without encryption.

In embodiments, logical cross checks can include a user's patterns and abnormalities in the patterns such as a wide change in location in short time, being in two places at once (which we temper with the understanding that they may leave an email open or want another user to monitor their email) however, we can impress our controls and the use of our approved devices to more closely monitor and thus automatically know precisely what is happening at all times.

In an embodiment, the invention uses the three credit bureaus for their worth, the gathering of judgments, liens, garnishments, parking tickets, existing credit (less useful but somewhat useful for cross check), FICO and introduce the things discussed elsewhere in this document.

In an embodiment, a QED (Quantum Entanglement Device) device as described in applicant's co-pending application Ser. No. 14/021,772 adds to the security of a transaction or credit offering. In an embodiment, items to be scanned, which can include tangible items such as another card or an item in a store or intangibles, such as a service agreement or web site, can include quantum entangled particles which are mated to a known entangled particle stored in a quantum entangled trap. An item marked with a quantum entangled particle can be securely and uniquely identified.

Item identification with location data’ Items on store shelves or in warehouses may beacon identity and unique identifiers to routers which know the location data for the item. Should the user utilize their digital device to scan in items, presuming the design is as automatic as possible, then the list of items the user has compiled is available for other applications to use for authenticity of the location and other uses, such as to selectively extend credit and terms based on what the user has or has not scanned into the list.

Security, cyber security, law enforcement, government, institution, hospital location services, emergency, or just standard day to day shopping and searching for items of interest or service discounts that will trigger the user to take action.

Credit can be offered based on a completely new methodology where the old system, essentially FICO® and three reports being taken into consideration, but this new weighting can add much more to the decision process. Not only standard purchases but new credit offerings are therefore possible.

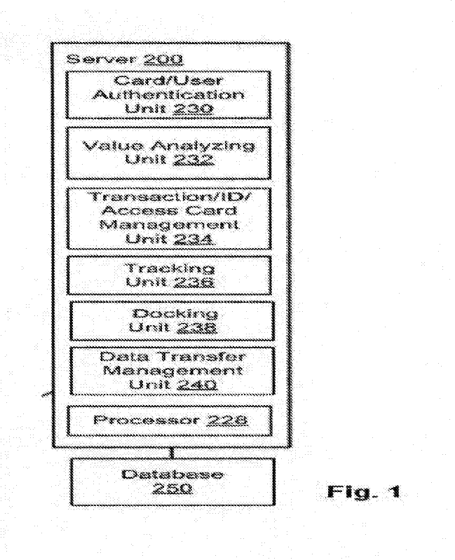

FIG. 1 shows an exemplary system 1 in which a ‘smart-card’ communicates with a server computer including plural units and memory for performing the various functions of the system via a network. The Card can communicate with a server 200 via a communications device such as the smart card.

The functions carried out by server include a database, a card/user authentication unit, a value analyzing unit 232, a transaction/ID/access card management unit 234, a tracking unit 236 that tracks card usage, patterns and other historical information related to the card and user and a data exchange unit that manages data exchange functions not handled by the card.

Further shown are the card/user authentication unit 230, a value analyzing unit 232, a transaction/ID/access card management unit 234, a tracking unit 236 that track card usage, patterns and other historical information related to card 100 and userId. The card/user authentication unit 230 handles processes related to identification, login, logout and related security features.

The present invention, in an embodiment, supports credit counseling ‘on the fly’ with settings stored by the system. A user can provide information to the system, such as marital status and income source and level, spouse's income source and level, and the system acquires a suitable setting, which may belong to a varying-size set of such settings. For example, if the user is thus set 607 as ‘conservative’, (low-risk) the system very closely advises and compresses credit. For example, one day, on 47th street in NY, the spouse wants a bigger diamond. The shopping, and idea of credit is all weighed in. One store agrees to 3 months, no interest, DONE. BUT, the system then parses out of our budget payment is made without draining credit sources, by reducing budget.

In an embodiment, the invention mandates that another user agree to any credit the user wants to undertake and add to your commerce, so as to pretty much shut out any intruder or identity theft. The user need only set a trusted person for third party verification of any one time new credit activation. Or a tree where one of the users in the tree is all that is needed to move forward. A new credit offer could also be allowed up to 10 bucks then limited until one of your tree members approves. Now the user can build an assured network of no fraud, no identity theft and smooth, easy transactions for everything at the lowest possible interest cost and with maximum savings, discounts, rebates and so on. A perfect system.

In an embodiment, the present invention makes use of a device, such as the one taught in 20140074696 which can sense all over its surface, gathering multibiometrics at all times for every action (and even inaction, just grasping and doing nothing) *exists*. Such a device equipped with encryption, GPS and a new form of RFID. These features collect and pass on location data tied to the biometric data 613. For example, it may be known that a user is with his device and both are located at location X with a probability of Y. The user also agreed in his TOS to allow servers to watch to see if he is anywhere else at the same time, which would indicate a problem. So with that data provided by the data exchange unit 240 and added in, key elements are known 10 times Y or better. Key elements may for example include the user's identity, his device’ electronic identity and his location tied in, all in real time and with high degree of certainty as compared to any method of the prior art.

That information, combined with his further agreement in his terms of service, to let the credit provider observe all the user's commerce (banking, etc. . . . ) by giving a deeper view of his credit, finances, worth and depth.

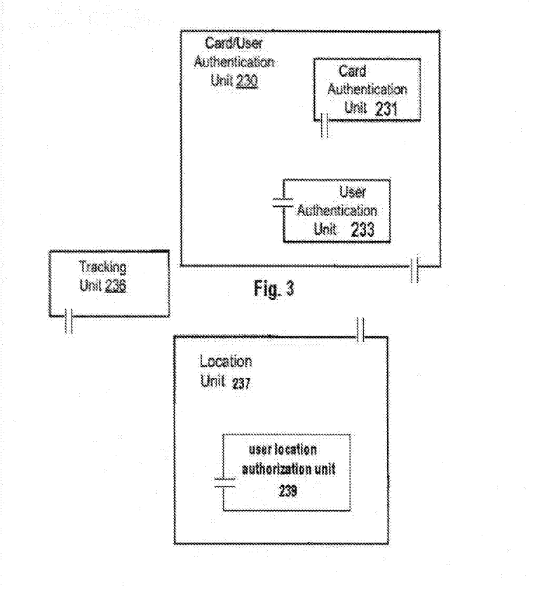

Referring now to FIG. 3, shown is a user location unit 237 and also a user location authentication unit, otherwise referred to as a user location authorization unit 239 is shown, most functions of which are substantially performed by a tracking unit 236, combines technologic advances to include locating means such as GPS (Global Positioning Systems, NFC (Near Field Communications) and RFID (Radio Frequency Interface Devices. In the context of this invention, pass fail rates for these data are not the limitation of the invention, rather, the combination of these data surviving outages, battery failure, even device exchange (backed up memory of) are required by the invention to generate differing forms of rolling values representing a scoring system which is taken into account when a user seeks any action at all, from a simple communications, powering on, powering off or a complex ecommerce transaction. In a more advanced embodiment, the user's devices talk to one another through any form of network available by and between these devices to share their embedded and learned location data, forming a separate combined location which can also be used independently to identify the devices' location(s). Therein, the devices can each independently report the location associated with the device in question and also the location of the associated devices 601. By doing this, the public enemy must break into more than one device to successfully trick a carrier or network into believing the location of a given device is authentic.

In an embodiment of the present invention, as shown in FIG. 3, the card/user authentication unit may incorporate card authentication unit and user authentication unit. Also, user location unit may incorporate user location authorization unit.

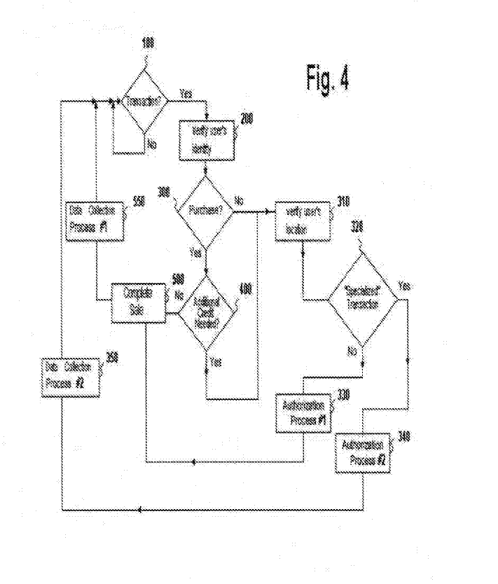

Referring to FIG. 4, in steps 200 and 310, further comparison of user attributes to previously stored identity and location data may, in some embodiments, be evaluated for consistency, such as for example across previous transaction and other user's other devices' data. In embodiments, step 550 includes item identification. In an example method of use, the present invention can offer flash credit at WalMart, because they dropped the price of a flat panel to 699 for just 7 units. This information is obtained by data exchange unit 240 and made available to the user by value analyzing unit 232. A user might be aware of a way to sell them for 799, readily. The user asks for credit to buy, promises to pay within 24 hours. His history and overall credit supports the decision. We also have the right to task all his CCs until he pays. He does the deal, 24 hours later, the credit offering is paid off. We make 99 dollars. (2% of the risk) We debit all the CCs we used as backing. The user makes 600 dollars. Obviously, anyone looking for bulk who can negotiate with a seller but needs credit to swing the deal (short term) can hugely benefit from this system.

In an embodiment, the data exchange unit 240 supplies information concerning behavior as exemplified by the foregoing to the server computer 200, boosting a credit score pertaining to the user which is kept by the provider of the service of the present invention. If he buys 2 mill a year and pays all as promised, he can walk into any setting and super buy. That venue would benefit greatly from the present credit scoring invention.

User identity authentication which, in embodiments, combine technologic advances to include voice print, retinal scan, finger print, capillary pattern, facial recognition, password, personal capcha and traditional logging functions including security questions, forming a first line of defense for the user. In the context of this invention, pass fail rates for these data are not the limitation of the invention, rather, the combination of these data surviving outages, battery failure, even device exchange (backed up memory of) are required by the invention to generate differing forms of rolling values representing a scoring system which is taken into account when a user seeks any action at all, from a simple communications, powering on, powering off or a complex ecommerce transaction. In a further example method of use, a credit offering of long term revolving credit is provided. Refinancing of house or home equity line literally as the user is walking around, is another example.

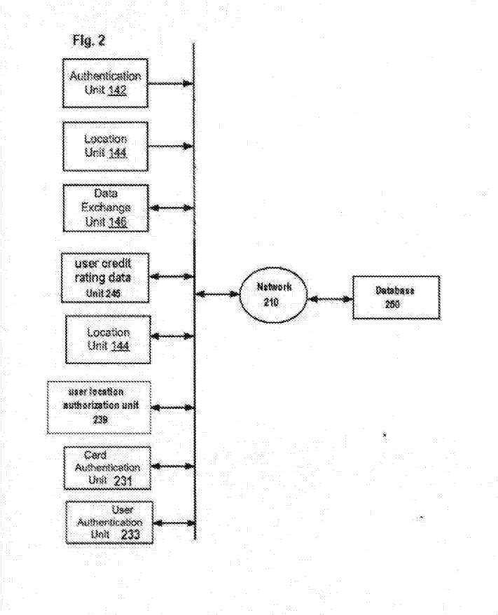

Credibility of offerings made under the present invention fall to the honesty and thoroughness in making each analysis. With these data and TOS agreement terms, the whole way of offering credit changes. In embodiments, user credit rating data includes pattern analysis for a unique user's user identity authentication(s), user device authentication(s) 600, user location authentication(s) and a user's actual authorized use of credit facilities, payment facilities, networks, software and all other possible uses of their devices, combined with traditional credit reporting bureau data, a new paradigm is provided from which better credit rating decisions can be made. From these ratings, credit offerings and credit facility use is hardened and improved to thwart identity theft and falsification of any particular transaction of any kind, including data access, communications and transactions the user undertakes. As shown in FIG. 2, a user credit rating data unit 245 conditions credit-specific data to be sent over the network 250 to the database and receives information from the database 626. Location unit 144 is a location determining unit, such as a global portioning system (GPS) receiver. Location information determined by location unit 144 is transmitted to the server 200, where it can be utilized by one or more system applications, such as value analyzing unit 232 and tracking unit 236. Also shown is card authentication unit 231, user authentication unit 233, user location unit 237 and user location authorization unit 239.

In a further method of use, a user owns 3 devices in particular, carried on a daily basis. Cell, CARD and laptop. Possibly a 4th as well, such as for example a wrist watch with epaper functions.

Logging, the devices own internal unique identifier, (as performed by card/user authentication unit 230) the devices talking to one another passing these data, (as performed by data exchange unit 240) each device gathering biometric data from the user's presence, all that data streamed and stored, forms up a final, singular value. The overall value must be this assured “XXX” plus, I must pass further tests of X, Y and Z (as performed by card/user authentication unit 230) to then conduct a communication, an ecommerce transaction or receive an automated offer of credit. Forensically, it's really unique. I have agreed to bear all, in return for best treatment of my finances etc. . . . Persons skilled in the art would find an extensive opportunity to create apps for this. In an exemplary embodiment, the system 1 and card 100 can store and relate information about the card owner, their immediate family, and/or others who may be with them on a given use of available local facilities and goods. Attributes for a card user are known to the card and the system can continuously or intermittently track mapping and information to the closest resources relating to the Individual.

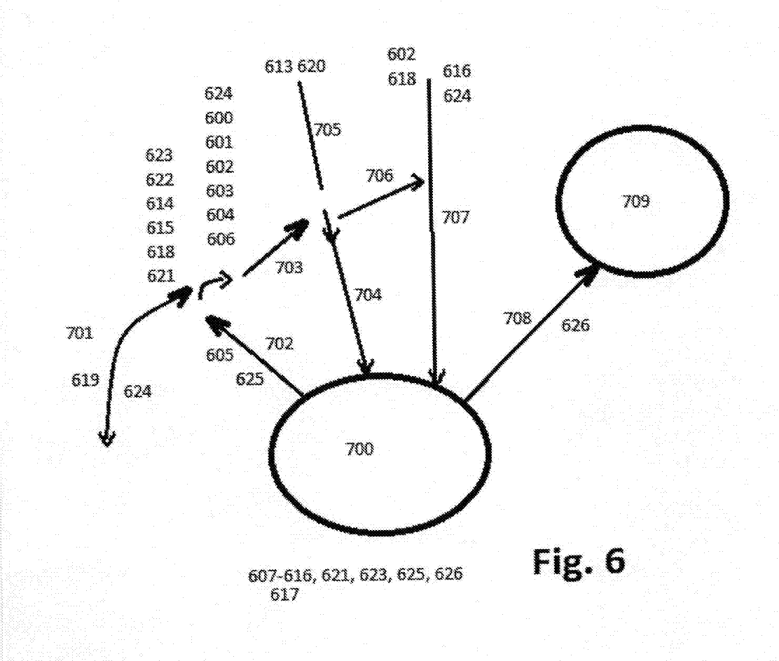

Referring now to FIG. 6, 701-708 are communication pathways, bi directional, between the listed elements, usually wireless in nature but can also be wired. Generally, 701 is a connection between the User's Device intending to make a transaction and the User's other local devices through 703. 702 is a communication pathway which reaches out to the User and can return back on path 704, such as to send a key and receive it back. Line 707 is very interesting in its use is for devices not owned by the user, yet are communicating with the system 700 through that line, and also, through 706, a local data share network which is secure, and then the data can be merged and sent back to the main system 700 through 704. 705 shows the biometric data from the User and their device, merging into the mix but maintaining its correlation with the action the user took, time and date, and any other data which serves to identify which device the user was using and their biometric or multibiometric data. 708 shows the system 700 making adjustments to and from the User's other credit and financial facilities. It is important to note the idea here is for a central system and for the User's other financial systems and credit provider systems, even venue systems, to intercommunicate. As such, all the devices the user owns and has on their person, plus, all the devices in proximity, can be creatively used to assure the location data is real. The key, the loop back of a key and the use of other devices not the user's, but able to transpond using processing overhead and communications, adds assurance the final data acted upon by system 700 is real, not counterfeit.

The present invention, in preferred embodiments, may perform one, some or all of the steps of:
retrieving a user's supposed identity from a network database
compiling the actual identity of the user through a plurality of actions taken by said user
using multi biometric readings to assure its the user
polling all the devices a user carries
polling nearby devices 602
accessing 619 the Combined data from all of the user's devices to assure device identity
accessing 620 the Combined data from a plurality of devices in proximity of the user to further assure the identity of the user's devices
further assuring location data is accurate by transmitting and receiving a local token to forward to the service provider where the token is unique, associated with the location. Thus verifying that all the said nearby devices would be . . . reporting the same token, we The service provider could send the token to the site and see it reflected back . . . before accepting the location data as being accurate.
sending the list of user scanned items 614, 615 to be considered for the credit offering, since, as mentioned above, per terms of service the provider of the services of the present invention can send and provide access to more species of financial and credit data 608
changing the users other credit means to allow more new credit
making the availability of net credit have to pass through your credit counseling settings to take effect.
automatically revolving the user's payments and facility use to meet said user's goals, such as more cash back or more frequent flyer miles.
making all the user's data available to competing credit companies so at any moment, the user may accept a new card and move your balances around.

All the above is automatic with perhaps the exception of making the list of the items the user is about to purchase 616, which requires the user to scan them. In an embodiment, generation of the list of items is made automatic because as the user puts the items in a shopping cart, the items move with them, thus it may be assumed the user is most likely going to buy them. Said objects moving with said user could form a basis for other deals presented, ads presented, discounts presented, credit offers presented as discussed above, rebates presented and automatically processed, buyer protection applied so if the item is cheaper within X days they get the discount automatically and other similar offers.

The various embodiments and depictions shown in this disclosure are to be considered non-limiting examples of the present invention. The invention is limited only by the attached claims. It is anticipated that persons skilled in the art, once shown this invention, will be able to modify concepts, platforms and procedures in ways to provide adaptations, without departing from the spirit of the invention.

1-3. (canceled)

4. A computer-implemented method of establishing a secure digital data connection to perform a transaction between a personalized secure mobile platform operated by a user and an institutional device, comprising executing on a processor steps of
agreeing through prior settings to allow at least a portion of said user's data to be accessible to said institutional device.
exchanging information between said devices to track, by said institutional device, the location of said personalized secure mobile platform
wherein
said institutional device connects to a network.
said mobile platform connects to a network.

5. The computer-implemented method of claim wherein said step of exchanging information to track, by said institutional device, the user's movement through means selected from the list of GPS, routers, wi fi, docking, blue tooth, proprietary connections, NIC connections, logging and transaction processes.

6. The computer-implemented method of claim further comprising the steps of:
retrieving a user's supposed identity from a network database
compiling the actual identity of the user through a plurality of actions taken by said user.

7. The computer-implemented method of claim 6 wherein said step of: compiling the actual identity of the user further comprises using at least one biometric reading to ensure the user's identity.

8. The computer-implemented method of claim 6 further comprising one or more steps selected from the list of:
polling a plurality of devices carried by the user
polling at least one nearby device
accessing the combined data from a plurality of the user's devices to assure device identity
accessing the combined data from at least one device in proximity to the user to further assure the identity of the user's devices.

9. The computer-implemented method of claim further comprising the steps of:
further assuring location data is accurate by transmitting and receiving a local token to forward to a service provider where the token is unique, associated with the location
verifying that all the said nearby devices are reporting the same token
sending the token to the site
seeing the token reflected back
accepting the location data as being accurate.

10. The computer-implemented method of claim further comprising the steps of:
compiling a list of user scanned items
sending the list of user scanned items to be considered for the credit offering.
changing the user's other credit means to allow more new credit per terms of service by accessing financial and credit data

11. The computer-implemented method of claim further comprising the step of making the availability of net credit have to pass through the user's credit counseling settings to take effect.

12. The computer-implemented method of claim further comprising the step of automatically revolving the user's payments and facility use to meet said user's goals, such as more cash back or more frequent flyer miles.

13. The computer-implemented method of claim further comprising the step of making at least a portion of said user's data available to competing credit companies so that the user may accept a new card with additional available credit.

14. The computer-implemented method of claim 5 wherein said step of tracking comprises tracking the user's movement in substantially real time through multiple tracking means.

15. The computer-implemented method of claim 5 further comprising tracking the user's movement through logging into email from a work station.

16. The computer-implemented method of claim 3 wherein said institutional device operates on behalf of a vendor and said transaction is a commercial transaction.

17. The computer-implemented method of claim 16 further comprising the step of: paying for said commercial transaction with a credit account.

18. The computer-implemented method of claim 17 further comprising the step of presenting an offer of additional credit to said user.

19. A non-transitory computer-readable medium for establishing a secure digital data connection to perform a transaction between a personalized secure platform and an institutional device comprising instructions stored thereon that, when executed on a processor, perform the steps of
agreeing through prior settings to allow at least a portion of said user's data to be accessible to said institutional device.
exchanging information to track, by said institutional device, the location of said personalized secure mobile platform
wherein
said personalized secure platform is connected to a network; and said institutional device connects to a network.

20. The non-transitory computer-readable medium of claim 19 wherein said step of exchanging information to track the user's movement through means selected from the list of GPS, routers, wi fi, docking, blue tooth, proprietary connections, NIC connections, logging and transaction processes.

21. The non-transitory computer-readable medium of claim 19 wherein said instructions, when executed on said processor, further perform the steps of:
retrieving a user's supposed identity from a network database
compiling the actual identity of the user through a plurality of actions taken by said user.

22. The non-transitory computer-readable medium of claim 19 wherein said institutional device operates on behalf of a vendor and said transaction is a commercial transaction.

23. A system for establishing a secure digital data connection comprising
a credit card “form-factor” mobile device comprising a microprocessor and a mixed array sensing and displaying surface and a wireless communication transceiver, having a primary side and a secondary side,
a substrate, imaging means, display means, a processor, memory and at least one magnetic region wherein said magnetic region is disposed on a device surface so as to effect a magnetic interaction with a standard “POS” swiping apparatus the microprocessor programmed to:
sense, using the sensing and displaying surface, a biometric characteristic from an object adjacent the sensing and displaying surface to generate biometric data pertaining to a user
sense, using the magnetic region, said magnetic interaction; and
a server comprising a CPU, a clock and a wireless communication transceiver, the CPU programmed to:
compare the generated data to stored biometric data; and
determine whether to accept the user based on the comparison.
